(19) United States
(12) Patent Application Publication
(10) Pub. No.: US 2006/0122724 A1
(43) Pub. Date: Jun. 8, 2006

(54) System and method for automatically generating a tooling specification using a logical operations utility that can be used to generate a photomask order

(75) Inventors: Charles E. Croke, Oakville, CT (US); Christopher J. Progler, Plano, TX (US); Hee Cheol Han, Chungcheongnam-do (KR); Chul You, Chungcheongnam-do (KR); Kyu Yeon Cho, Chungcheongnam-do (KR); Hyung Jin Joo, Gyeonggi-do (KR)

Correspondence Address: AMSTER, ROTHSTEIN & EBENSTEIN LLP, 90 PARK AVENUE, NEW YORK, NY, 10016, US

(73) Assignee: PHOTORONICS, INC. 15 SECOR ROAD P.O. BOX 5226 BROOKFIELD, CONNECTICUT 06804

(21) Appl. No.: 11/006,525

(22) Filed: Dec. 7, 2004

(51) Int. Cl. G06F 19/00

(52) U.S. Cl. 700/121; 700/117; 716/21

(57) ABSTRACT

A method of generating a photomask order used to manufacture photomasks using a tooling specification generating system including generating a tooling specification by creating, modifying and/or deleting components of a logical operation that is represented by the tooling specification. Information required for the logical operation may be imported from an external source, such as a database, and/or may be chosen from look-up lists. Aliases for the operators that make up expressions in the logical operation may be modified as desired by the photomask customer. The format of the tooling specification may be verified by the photomask customer's computer system. The tooling specification is sent to a computer system of a photomask manufacturer in various proprietary and industry standard formats for analysis of the tooling specification, and the photomask design may be simulated using the tooling specification. After receiving the analysis results, the photomask customer's computer system generates the photomask order based on the tooling specification. The photomask order is then sent to the computer system of a photomask manufacturer for manufacture of the photomask. The tooling specification generating system may be a stand-alone system or be integrated with a photomask order generating system.

### FIELD OF THE INVENTION

The present invention generally relates to a system and method for generating a tooling specification, including photomask design information, that can be used to generate a photomask order. More particularly, the present invention relates to a software-based application which can generate a tooling specification, including photomask design information, which can be transferred to a photomask manufacturer's processing system to allow the photomask manufacturer's processing system to verify validity, feasibility and/or desirability of the design. The present invention further relates to a system and method for generating a tooling specification, including design information, using a tooling specification generating system which is user friendly and adaptable for use with various fracture engine formats.

### BACKGROUND OF THE INVENTION

Photomasks are high precision plates containing microscopic images of electronic circuits. Photomasks are typically made from very flat pieces of quartz or glass with a layer of chrome on one side. Etched in the chrome is a portion of an electronic circuit design. This circuit design on the mask is also called “geometry.”

A typical photomask used in the production of semiconductor devices is formed from a “blank” or “undeveloped” photomask. As shown in FIG. 1, a typical blank photomask 10 is comprised of three or four layers. The first layer 11 is a layer of quartz or other substantially transparent material, commonly referred to as the substrate. The next layer is typically a layer of opaque material 12, such as Cr, which often includes a third layer of antireflective material 13, such as CrO. The antireflective layer may or may not be included in any given photomask. The top layer is typically a layer of photosensitive resist material 14. Other types of photomasks are also known and used including, but not limited to, phase shift masks, embedded attenuated phase shift masks (“EAPSM”) and alternating aperture phase shift masks (“AAPSM”).

The process of manufacturing a photomask involves many steps and can be time consuming. In this regard, to manufacturer a photomask, the desired pattern of opaque material 12 to be created on the photomask 10 is typically defined by an electronic data file loaded into an exposure system which typically scans an electron beam (E-beam) or laser beam in a raster or vector fashion across the blank photomask. One such example of a raster scan exposure system is described in U.S. Pat. No. 3,900,737 to Collier. Each unique exposure system has its own software and format for processing data to instruct the equipment in exposing the blank photomask. As the E-beam or laser beam is scanned across the blank photomask 10, the exposure system directs the E-beam or laser beam at addressable locations on the photomask as defined by the electronic data file. The areas of the photosensitive resist material that are exposed to the E-beam or laser beam become soluble while the unexposed portions remain insoluble. In order to determine where the E-beam or laser beam should expose the photoresist 14 on the blank photomask 10, and where it should not, appropriate instructions in the form of a jobdeck need to be provided to the processing equipment.

After the exposure system has scanned the desired image onto the photosensitive resist material 14, as shown in FIG. 2, the soluble photosensitive resist material is removed by means well known in the art, and the unexposed, insoluble photosensitive resist material 14′ remains adhered to the opaque material 13 and 12. Thus, the pattern to be formed on the photomask 10 is formed by the remaining photosensitive resist material 14′.

The pattern is then transferred from the remaining photoresist material 14′ to the photomask 10 via known etch processes to remove the antireflective material 13 and opaque materials 12 in regions which are not covered by the remaining photoresist 14′. There is a wide variety of etching processes known in the art, including dry etching as well as wet etching, and thus a wide variety of equipment is used to perform such etching. After etching is complete, the remaining photoresist material 14′ is stripped or removed and the photomask is completed, as shown in FIG. 3. In the completed photomask, the pattern as previously reflected by the remaining antireflective material 13′ and opaque materials 12′ are located in regions where the remaining photoresist 14′ remain after the soluble materials were removed in prior steps.

In order to determine if there are any unacceptable defects in a particular photomask, it is necessary to inspect the photomasks. A defect is any flaw affecting the geometry. This includes undesirable chrome areas (chrome spots, chrome extensions, chrome bridging between geometry) or unwanted clear areas (pin holes, clear extensions, clear breaks). A defect can cause the customer's circuit not to function. The customer will indicate in its defect specification the size of defects that will affect their process. All defects of that size and larger must be repaired, or if they cannot be repaired, the mask must be rejected and rewritten.

Typically, automated mask inspection systems, such as those manufactured by KLA-Tencor or Applied Materials, are used to detect defects. Such automated systems direct an illumination beam at the photomask and detect the intensity of the portion of the light beam transmitted through and reflected back from the photomask. The detected light intensity is then compared with expected light intensity, and any deviation is noted as a defect. The details of one system can be found in U.S. Pat. No. 5,563,702 assigned to KLA-Tencor.

After passing inspection, a completed photomask is cleaned of contaminants. Next, a pellicle may be applied to the completed photomask to protect its critical pattern region from airborne contamination. Subsequent through pellicle defect inspection may be performed. In some instances, the photomask may be cut either before or after a pellicle is applied.

To perform each of the manufacturing steps described above, a semiconductor manufacturer (e.g., customer) must first provide a photomask manufacturer with different types of data relating to the photomask to be manufactured. In this regard, a customer typically provides a photomask order which includes various types of information and data which are needed to manufacture and process the photomask, including, for example, data relating to the design of the photomask, materials to be used, delivery dates, billing information and other information needed to process the order and manufacture the photomask.

A long standing problem in the manufacture of photomasks is the amount of time it takes to manufacture a photomask from the time a photomask order is received from a customer. In this regard, the overall time it takes to process a photomask order and manufacture a photomask can be lengthy, and thus, the overall output of photomasks is not maximized. Part of this problem is attributable to the fact that many customers who order photomasks often place their orders in a variety of different formats which are often not compatible with the photomask manufacturer's computer system and/or manufacturing equipment. Accordingly, the photomask manufacturer is often required to reformat the order data and condition, convert, and/or supplement it to a different format which is compatible with its computer system and/or manufacturing equipment, which can take a great deal of time, and thus, delay the time it takes to manufacture a photomask.

In an attempt to address these problems, the photomask industry has developed various standard photomask order formats in which photomask orders should be placed. For example, the SEMI P-10 standard is one standard format used in the manufacture of photomasks. Additionally, a few semiconductor manufacturers have developed their own proprietary photomask order format in which photomask orders are to be placed, rather than adopting a standard format. These standard and proprietary photomask order formats were created so that photomask orders would be received from customers in a uniform format, thereby reducing the overall time it takes to manufacture a photomask.

Although the use of such standard and/or proprietary photomask order formats are useful in reducing the time it takes to manufacture photomasks, many semiconductor manufacturers have been reluctant to place their photomask orders in such standard and/or proprietary formats for a variety of reasons. For example, the SEMI P-10 standard order format is quite complicated and requires the customer placing the order to have a sophisticated working knowledge of the requirements associated with such standard. Since many semiconductor manufacturers do not manufacture photomasks, such manufacturers may not have the resources, time or ability to learn the intricacies of such standard format. Thus, semiconductor manufacturers often provide a photomask manufacturer with photomask order data in an unorganized and often incomplete manner. As a result, the photomask manufacturer is required to parse through this data and organize it in a useful format (e.g., in the SEMI P-10 format). Moreover, typically these standard and proprietary formats require a complete order to be submitted. Moreover, these standards do not include a standard format in which a tooling specification alone may be transferred for analysis. There has been a long felt need in the field of photomask manufacture for a customer side system and method for automatically generating tooling specifications for a photomask order in a standard and/or proprietary format which can be transmitted to a photomask manufacturer to verify validity, feasibility and/or desirability of a particular design and thereafter be used to generate a photomask order.

In the past, AlignRite Corporation (a predecessor organization to Photronics, Inc.), attempted to expedite the delivery of the electronic data through the use of an Internet based delivery system. However, although the AlignRite System was capable of rapid delivery of the photomask data from a customer to the computer system of the photomask manufacturer and was capable of validating the accuracy of this data in real time, this prior system did not provide for the automated generation of photomask order data in a single standard and/or proprietary format. In this regard, once the data was received from the customer, standard modifications to the data would also have to be entered manually by operators. Each time a manual change would have to be entered, the risk of human error increased and the overall length of the job would be extended. Further, the AlignRite System did not allow for the transfer of merely automatically generated tooling instructions, which could be used to verify validity, feasibility and/or desirability of a particular photomask order and thereafter generate a photomask order.

Since then, others have disclosed systems in which manufacturing and billing data are down-loaded over the Internet and verified on-line automatically. One such system is described in PCT Publication Number 02/03141, published on Jan. 10, 2002 to DuPont Photomask, Inc. which is also the subject of U.S. Pat. No. 6,622,295. More particularly, the DuPont PCT Publication discloses a system in which photomask order data is entered on-line by a customer and transmitted to a photomask manufacturer for processing. In this system, a customer is prompted to enter photomask order data. Such data is transmitted to a photomask manufacturer, who in turn performs a diagnostic evaluation of the data. If any data is incomplete or inaccurate, the system sends a message to the customer notifying him of such error. Thereafter, the user must correct the error. After the data has been validated by the manufacturer (and corrected when necessary), the manufacturer processes this data and puts it into a standard (or proprietary) format, such as the SEMI P-10 standard format.

Although useful for diagnostic purposes, the system of the DuPont PCT Publication is very cumbersome and provides a user with very little flexibility in formulating a photomask order or more particularly tooling specifications. Further, the system of the DuPont PCT Publication also requires a user to enter complete orders and provides for no diagnostic or feedback on how a design included in the order may be improved. Thus, there is a long felt need for a system and method which generates tooling specifications including fracturing instructions that are simple and which may then be analyzed for validity, feasibility and/or desirability of the design prior to submitting a completed order and then used thereafter to create an order.

Similarly, Photronics in the past has developed its own photomask order generating system and method. For example, Photronics, the assignee of the present invention, has in the past developed its own MaskPilot® system, which has demonstrated tremendous commercial success. This system is the subject of U.S. patent application Ser. No. 10/209,254, filed on Jul. 30, 2004, and Ser. No. 10/877,011, filed on Jun. 25, 2004, all assigned to a common assignee. Each of these disclosures is incorporated by reference herein. The MaskPilot® system has a customer enter a complete photomask order information using a graphical user interface in the form of a template or order. This system does not provide for a customer to enter and transmit to a photomask manufacturer an incomplete order containing only tooling specifications used to generate fracture instructions.

Still others overseas have generated incomplete photomask orders, including design information, in a format which has allowed a photomask manufacturer to verify the validity, feasibility and/or desirability of the design. One such system is disclosed in U.S. patent application Ser. No. 10/877,001, filed on Jun. 24, 2004 by the same assignee, the disclosure of which is hereby incorporated by reference in its entirety. An example of such a system has been used by a Korean photomask customer to supply tooling specifications to PKL, an affiliate of Photronics, Inc. These systems appear to be very simple and do not provide the photomask customer with flexibility in generating the tooling specification, and cannot be used in connection with other software to generate a complete order after the design has been analyzed. Further, the output files of such a system are postscript text files which need to be further processed in order to be reformatted into a format that could be used for different fracture engines. These systems also fail to import information from other systems to generate the tooling specifications. Overall, the lack of flexibility and functionality of this prior art system renders it lacking and has created a need for a user friendly and flexible system and method for generating tooling specifications.

After the manufacturing steps described above are completed, the completed photomask is sent to a customer for use to manufacture semiconductor and other products. In particular, photomasks are commonly used in the semiconductor industry to transfer micro-scale images defining a semiconductor circuit onto a silicon or gallium arsenide substrate or wafer. The process for transferring an image from a photomask to a silicon substrate or wafer is commonly referred to as lithography or microlithography. Typically, as shown in FIG. 4, the semiconductor manufacturing process comprises the steps of deposition, photolithography, and etching. During deposition, a layer of either electrically insulating or electrically conductive material (like a metal, polysilicon or oxide) is deposited on the surface of a silicon wafer. This material is then coated with a photosensitive resist. The photomask is then used much the same way a photographic negative is used to make a photograph. Photolithography involves projecting the image on the photomask onto the wafer. If the image on the photomask is projected several times side by side onto the wafer, this is known as stepping and the photomask is called a reticle.

As shown in FIG. 5, to create an image 21 on a semiconductor wafer 20, a photomask 10 is interposed between the semiconductor wafer 20, which includes a layer of photosensitive material, and an optical system 22. Energy generated by an energy source 23, commonly referred to as a Stepper, is inhibited from passing through the areas of the photomask 10 where the opaque material is present. Energy from the Stepper 23 passes through the transparent portions of the quartz substrate 11 not covered by the opaque material 12 and the antireflective material 13. The optical system 22 projects a scaled image 24 of the pattern of the opaque material 12 and 13 onto the semiconductor wafer 20 and causes a reaction in the photosensitive material on the semiconductor wafer. The solubility of the photosensitive material is changed in areas exposed to the energy. In the case of a positive photolithographic process, the exposed photosensitive material becomes soluble and can be removed. In the case of a negative photolithographic process, the exposed photosensitive material becomes insoluble and unexposed soluble photosensitive material is removed.

After the soluble photosensitive material is removed, the image or pattern formed in the insoluble photosensitive material is transferred to the substrate by a process well known in the art which is commonly referred to as etching. Once the pattern is etched onto the substrate material, the remaining resist is removed resulting in a finished product. A new layer of material and resist is then deposited on the wafer and the image on the next photomask is projected onto it. Again the wafer is developed and etched. This process is repeated until the circuit is complete. Because, in a typical semiconductor device many layers may be deposited, many different photomasks may be necessary for the manufacture of even a single semiconductor device. Indeed, if more than one piece of equipment is used by a semiconductor manufacturer to manufacturer a semiconductor device, it is possible more than one photomask may be needed, even for each layer. Furthermore, because different types of equipment may also be used to expose the photoresist in the different production lines, even the multiple identical photomask patterns may require additional variations in sizing, orientation, scaling and other attributes to account for differences in the semiconductor manufacturing equipment. Similar adjustments may also be necessary to account for differences in the photomask manufacturer's lithography equipment. These differences need to be accounted for in the photomask manufacturing process.

While the prior art is of interest, the known methods and apparatus of the prior art present several limitations which the present invention seeks to overcome.

In particular, it is an object of the present invention to provide a system and method for generating at least a portion of a photomask order including design information in a format which can be transferred to a photomask manufacturer's processing system to allow the photomask manufacturer to verify the validity, feasibility and/or desirability of the design.

It is another object of the present invention to provide a system and method for automatically generating a tooling specification including fracturing instructions that can be used to generate a photomask order using a tooling specification generating system to allow the photomask manufacturer to verify the validity, feasibility and/or desirability of the design and thereafter generate an appropriate photomask order.

It is another object of the present invention to provide a system and method for generating a tooling specification to be used to generate a photomask order that can import and condition specification data from other sources.

It is further object of the present invention that such a tooling specification generating system include flexible and user friendly tools, such as, the ability to use user defined symbolic operations in conjunction with or instead of default symbolic operations and populate some or all of the optional or required data entry points used to create the tooling specification.

It is further object of the present invention that such tooling specification generating system be capable of generating tooling specifications in various industry standard or proprietary photomask data formats including but not limited to GDSII, Mebes, Oasis, DXF, Applican, .cflt, .cinc, .ps, etc.

It is another object of the present invention that such tooling specification generation system be capable of being a stand alone system capable of generating tooling specifications that can be used in conjunction with other photomask order generation systems, or may be a utility which is integrated with a photomask order generation system.

It is another object of the present invention that such tooling specification generating system be accessed by a user using a graphical user interface, a traditional wizard and/or a command generator.

It is another object of the present invention to provide an automatic tooling specification generating system for reducing transcription errors associated with the manual entry of fracture instructions.

It is another object of the present invention to provide a tooling specification generating system which can be used to increase the overall output of photomasks being manufactured.

It is another object of the present invention to solve the shortcomings of the prior art.

Other objects will become apparent from the foregoing description.

### SUMMARY OF THE INVENTION

In a tooling specification generating system according to an exemplary embodiment of the invention, design data is extracted from databases or other files and imported in varying formats on a photomask customer's system or other external systems accessible by the photomask customer's computer. Tooling specification data may be also entered based on prompting by a graphical user interface, wizard and/or by the use of scripted commands. The logical operations utility may use user defined unique symbolic representations for operations used within a logical expression and/or predefined symbolic operations. The tooling specification generating system may be linked with rules that are separately stored, and thus easily updateable, which can be used to insure complete and accurate data is included in the tooling specification. Partial or complete tooling specification data may also be imported electronically, e.g., by scanning and or conversion from other file formats. Once entered, the tooling specification data may be further modified or submitted without further modification. When a tooling specification is entered, the information associated with that tooling specification may be transferred electronically to a photomask manufacturer for verification of the validity, feasibility and/or desirability of the design. After confirmation of the validity, feasibility and desirability of the design (either as submitted or as further modified), the tooling specification may be combined with other data necessary to generate a complete photomask order, and resubmitted to the photomask manufacturer as a complete order.

The tooling specification generating system according to embodiments of the present invention may be a stand-alone system whose tooling specification output is compatible with a photomask order generating system so that it can be used to generate a photomask order. Alternatively, the tooling specification generating system may be integrated directly into a photomask order generation system where photomask order attributes may be shared between both systems and used to populate data fields in either system. When used either as part of, or in conjunction with a photomask order generation system, the tooling specification generating system may allow a user to automatically populate some or all of the optional or required data entry points used to create a tooling specification.

The tooling specification output of the tooling specification generating system may be in a general text format, or in various other formats such as GDSII, Mebes, Oasis, DXF, Applican, .cflt, and .cinc. The tooling specification output may be in an industry format that may be recognized and used by photolithographic equipment as software used for Computer Aided Design or Electronic Design Automation. Alternatively, the tooling specification output may be industry formats such as XML, SOAPXML, post-script, HTML, ASCII, to name a few.

A method of manufacturing a photomask according to an embodiment of the present invention includes receiving a tooling specification from a computer system of a photomask customer and analyzing the tooling specification. Results of the analysis are sent to the computer system of the photomask customer, a photomask order generated based on the tooling specification is received, and a photomask is manufactured based on the photomask order.

A method of generating a photomask order used to manufacture photomasks according to an exemplary embodiment of the invention includes generating a tooling specification by creating, modifying and/or deleting components of a logical operation that is represented by the tooling specification and sending the tooling specification to a computer system of a photomask manufacturer for analysis of the tooling specification. Results of the analysis are received from the computer system of the photomask manufacturer, a photomask order is generated based on the tooling specification, and the photomask order is sent to the computer system of the photomask manufacturer.

A method of processing a photomask order according to an exemplary embodiment of the invention includes receiving a tooling specification from a computer system of a photomask customer and analyzing the tooling specification. Results of the analysis are sent to the computer system of the photomask customer, and a photomask order generated based on the tooling specification is received.

A method of generating a tooling specification using a tooling specification generating system according to an exemplary embodiment of the invention includes importing data relating to at least one component of a logical operation from a source external to the specification generating system and generating a tooling specification based on the at least one component of the logical operation. The tooling specification is sent to a computer system of a photomask manufacturer for analysis of the tooling specification.

A method of generating a tooling specification used to manufacture photomasks according to an exemplary embodiment of the invention includes generating a tooling specification by creating, modifying and/or deleting components of a logical operation that is represented by the tooling specification, and outputting the tooling specification in a format in accordance with a particular standard and/or proprietary photomask order format.

A method of generating a photomask order used to manufacture photomasks according to another exemplary embodiment of the invention includes generating a tooling specification by creating, modifying and/or deleting at least one component of a logical operation using at least one of a graphical user interface, a wizard and a command generator, the logical operation being represented by the tooling specification and sending the tooling specification to a computer system of a photomask manufacturer for analysis of the tooling specification. Results of the analysis are received from the computer system of the photomask manufacturer, a photomask order is generated based on the tooling specification, and the photomask order is sent to the computer system of the photomask manufacturer.

A method of generating a photomask order used to manufacture photomasks according to another exemplary embodiment of the invention includes generating a tooling specification by creating, modifying and/or deleting components of a logical operation that is represented by the tooling specification, the tooling specification including fracturing instructions for a photomask design, and simulating the photomask design using the fracturing instructions. The tooling specification is analyzed based on the simulated photomask design, a photomask order is generated based on the tooling specification, and the photomask order is transmitted to a computer system of a photomask manufacturer.

A method of generating a photomask order used to manufacture photomasks according to another exemplary embodiment of the invention includes generating a tooling specification by creating, modifying and/or deleting components of a logical operation that is represented by the tooling specification, and verifying that the tooling specification is in a proper format. The tooling specification is sent to a computer system of a photomask manufacturer for analysis of the tooling specification and the analysis is received from the computer system of the photomask manufacturer. A photomask order is generated based on the tooling specification and the photomask order is sent to the computer system of the photomask manufacturer.

A method of generating a tooling specification used to manufacture photomasks according to another exemplary embodiment of the invention includes at least one of creating, modifying and deleting components of a logical operation, the components comprising at least one expression having an operator and at least one alias corresponding to the operator, and modifying the at least one alias from a default value. A tooling specification is generated based on the logical operation comprising the modified at least one alias.

A photomask order generating system used to manufacture photomasks according to an exemplary embodiment of the invention includes a tooling specification generator for creating, modifying and/or deleting components of a logical operation that is represented by a tooling specification, a tooling specification analyzer that analyzes the tooling specification, and a photomask order generator that generates a photomask order based on the tooling specification and that transmits the photomask order to a computer system of a photomask manufacturer.

A photomask order generating system used to manufacture photomasks according to another exemplary embodiment of the invention includes a tooling specification generator for creating, modifying and/or deleting components of a logical operation that is represented by the tooling specification, the tooling specification including fracturing instructions for a photomask design, a photomask design simulator that simulates the photomask design using the fracturing instructions, and a photomask order generator that generates a photomask order based on the tooling specification and that transmits the photomask order to a computer system of a photomask manufacturer.

A tooling specification generating system used to manufacture photomasks according to an exemplary embodiment of the invention includes a logical operations manager for at least one of creating, modifying and deleting components of a logical operation, the components comprising at least one expression having an operator and at least one alias corresponding to the operator, and an alias manager for modifying the at least one alias from a default value. A tooling specification generator generates a tooling specification based on the logical operation including the modified at least one alias.

A tooling specification generating system according to an exemplary embodiment of the invention includes a data importer for importing data relating to at least one component of a logical operation from a source external to the tooling specification generating system, a tooling specification generator for generating a tooling specification based on the at least one component of the logical operation, and a tooling specification analyzer including a file transmitter that transmits the tooling specification to a computer system of a photomask manufacturer for analysis of the tooling specification.

A photomask order generating system according to an exemplary embodiment of the invention includes a tooling specification generator for creating, modifying and/or deleting at least one component of a logical operation using at least one of a graphical user interface, a wizard and a command generator, the logical operation being represented by the tooling specification, a tooling specification analyzer that sends the tooling specification to a computer system of a photomask manufacturer for analysis of the tooling specification, and a photomask order generator that generates a photomask order based on the tooling specification and that sends the photomask order to the computer system of the photomask manufacturer.

A photomask order generating system according to an exemplary embodiment of the invention includes a tooling specification generator for creating, modifying and/or deleting components of a logical operation that is represented by the tooling specification, and a logical operation verifier for verifying that the logical operation is in a proper format. A tooling specification analyzer sends the tooling specification to a computer system of a photomask manufacturer for analysis of the tooling specification, and a photomask order generator generates a photomask order based on the tooling specification and sends the photomask order to the computer system of the photomask manufacturer.

A computer readable medium containing computer readable instructions for a computer to perform a method according to an exemplary embodiment of the invention includes generating a tooling specification by creating, modifying and/or deleting components of a logical operation that is represented by the tooling specification, and sending the tooling specification to a computer system of a photomask manufacturer for analysis of the tooling specification. The tooling specification is received from the computer system of the photomask manufacturer, a photomask order is generated based on the tooling specification, and the photomask order is sent to the computer system of the photomask manufacturer.

In at least one embodiment, the components of the logical operation include at least one of: data layer attributes, input data attributes, expressions, pattern groups and aliases.

In at least one embodiment, the step of importing data is done using at least one of a command line generator and a scanner.

In at least one embodiment, the external source is at least one of: a database, a GDSII file, a MEBES file and a photomask order template.

In at least one embodiment, the external source is a database, and the database is shared with the computer system of the photomask manufacturer.

In at least one embodiment, at least one of the components of the logical operation is chosen from at least one look-up list.

In at least one embodiment of the invention, the format of the tooling specification is verified using a set of rules.

In at least one embodiment of the invention, the tooling specification is translated into a format that can be used by third party data fracturing applications.

In at least one embodiment of the invention, the various proprietary and standard photomask data formats include at least one of: GDSII, MEBES, Oasis, DXF, Applican, .cflt, .cinc and .ps.

In at least one embodiment of the invention, the computer system of the photomask manufacturer analyzes the tooling specification to determine at least one of validity, feasibility and desirability of the tooling specification.

In at least one embodiment of the invention, the results of the analysis include at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

In at least one embodiment of the invention, the tooling specification is analyzed using the simulated photomask design.

These and other features of this invention are described in, or are apparent from, the following detailed description of various exemplary embodiments of this invention.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 represents a blank or undeveloped photomask of the prior art;

FIG. 2 represents the photomask of FIG. 1 after it has been partially processed;

FIG. 3 represents the photomask of FIGS. 1 and 2 after it has been fully processed;

FIG. 4 is a flowchart showing the method of using a processed photomask to make or process a semiconductor wafer;

FIG. 5 shows the process of making a semiconductor using a wafer stepper;

FIG. 6 shows a photomask customer's computer system, including a tooling specification generating system according to an exemplary embodiment of the invention, used in conjunction with a photomask manufacturer's computer system; and

FIGS. 7-13 shows various screens of an exemplary graphical user interface used with the invention to guide a user to enter specified data.

FIG. 14 is a flowchart showing a method of manufacturing a photomask using a tooling specification generating system according to an exemplary embodiment of the invention.

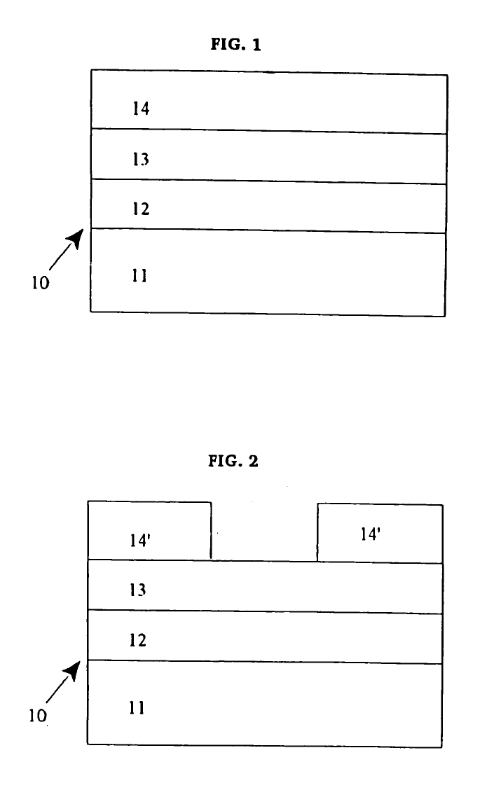

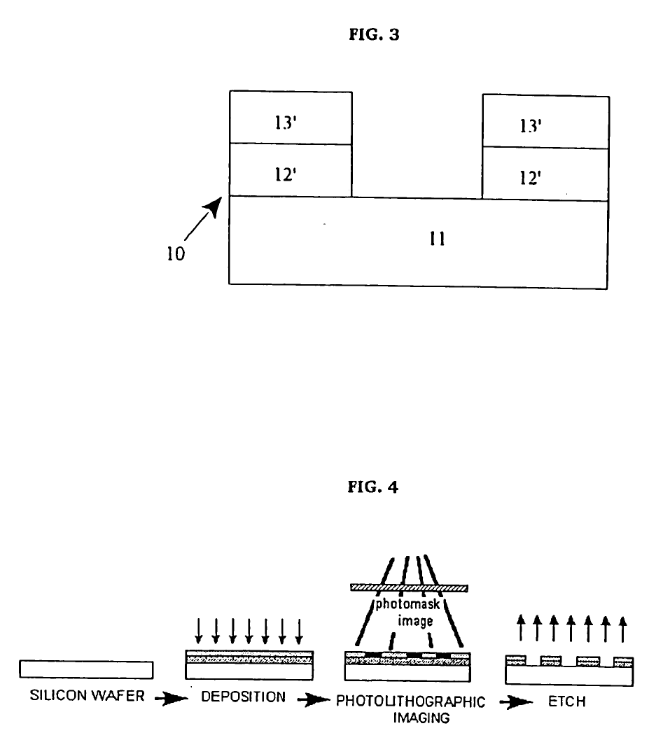

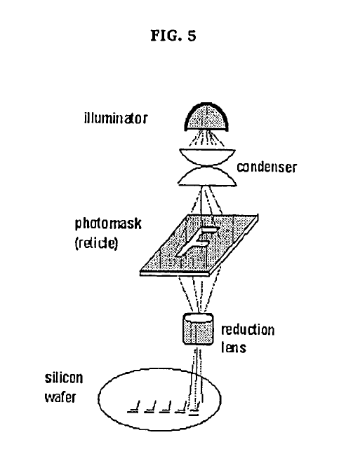

### DETAIL DESCRIPTION OF THE PREFERRED EMBODIMENT(S)

The various exemplary embodiments of the present invention relate to a computerized system and method for generating an electronic file that represents instructions to fracture data, which will be used to manufacture photomasks. In particular, the system and method provides end users, such as photomask customers, with the ability to create logical operations, components of which make up a tooling specification and which contain the data fracturing instructions for one or more layers of a photomask. As will be explained in more detail below, a logical operation may include expressions, data layer attributes, input data attributes, pattern groups and aliases. Specific information may be retrieved from external sources such as, for example, a MaskPilot® template or an input data file, to pre-populate attributes within the logical operation. In addition, the end user has the capability of selecting aliases, which are symbolic representations of operators used in expressions, to which the end user is most accustomed.

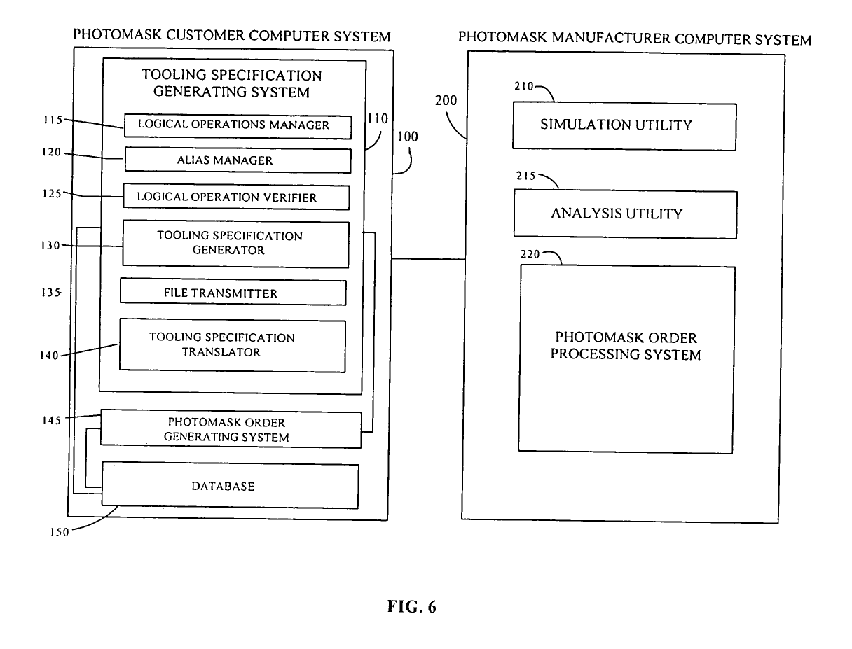

FIG. 6 shows a photomask customer's computer system 100, including a tooling specification generating system 110 according to an exemplary embodiment of the invention, used in conjunction with a photomask manufacturer's computer system 200. The tooling specification generating system 110 includes a logical operation manager 115, an alias manager 120, a logical operation verifier 125, a tooling specification generator 130, a file transmitter 135 and a tooling specification translator 140. As explained further below, an end user is able to use the various components of the tooling specification generating system 110 to create a logical operation that represents instructions to fracture data, which will be used by a photomask order generating system 145, such as, for example, MaskPilot®, to generate a tooling specification for a photomask manufacturing process. It should be appreciated that the present invention is not limited to use with MaskPilot®, and may be used with any other photomask order generating system. Although FIG. 6 illustrates the tooling specification generating system 110 as a stand-alone system in relation to the photomask order generating system 145, it should be appreciated that in other exemplary embodiments of the invention the tooling specification generating system 110 may be integrated with the photomask order generating system 145. Also, as further explained below, one or more separately maintained databases 150 may store and supply information used by the tooling specification generating system 110. The databases 150 may be shared by the photomask order generating system 145.

The logical operation manager 115 is used by the end user to create, modify and/or delete a logical operation. A logical operation is a collection of data layer attributes, input data attributes, expressions, pattern groups and aliases, which will be used to create a tooling specification. Data layer attributes define a layer name, a layer number and input data reference number for a particular mask layer. Parts of this information may later be used as an operand when creating an expression. Examples of attributes that fall into the category of “data layer” may include Layer Name and Layer Number, to name a few. Input data attributes define the parameters needed to manipulate data for the purpose of creating a tooling specification. Examples of attributes that fall into the category of “Input Data” may include Input File Name, Top Structure, Snap Grid, Rotation and Alignment, to name a few. A pattern group is an alphanumeric description of the pattern category for input data attributes. Examples of pattern groups may include Primary, Test, Frame and Scribe, to name a few. Expressions, as the term is conventionally used in computer languages, are made up of operands, which are the objects that are manipulated, and operators, which are the symbols or commands that represent specific actions. Aliases are symbolic representations of operators.

The logical operation manager 115 allows the end user to enter data to create a logical operation. In addition, the logical operations manager 115 may include a data importer (not shown) that imports data from external sources to create the logical operation. The data importer may include, for example, a command line generator and/or a scanner. As an example, the system 110 may allow values within attributes to be imported from sources such as, for example, GDSII files, MEBES files and one or more MaskPilot® templates, to name a few. In addition, a database 150 may be maintained separately or integral to the tooling specification generation system 100 that contains information for the various attributes of the logical operation.

The saved logical operation is completely modifiable and deleteable, either in whole or in part. For example, the previously saved logical operation may be retrieved based on selectable lists of attributes and then modified by, for example, removing mask layers from the logical operation. If created from one or more MaskPilot® templates, the logical operation will “know” from which MaskPilot® template(s) it was formed so that mask layers can be added to the logical operation from one or more MaskPilot® templates. In addition, aliases are preferably stored separately for each logical operation, so that modification or deletion of an alias will not affect an existing logical operation. In this regard, a logical operation will preferably “know” the aliases for its expressions. For example, each logical operation may use the “default” aliases that were installed with the system, but, as explained further below, the end user preferably has the ability to change that selection at any time.

The alias manager 120 allows the end user to create one or more aliases for any operator used in an expression. For example, the system 110 may contain a set of operators that each logical operation may use by default. For those operators, the end user may be able to substitute their own representations. For example, the end user may choose to substitute the operator defined as “AND” with a “+”. This feature is not restricted to single character representations or operators, although it is preferably restricted to unique character representations within a set of aliases. Aliases can be saved within the system 110 after creation, and can later be retrieved for modification or deletion.

The logical operation verifier 125 provides the end user with the ability to verify the integrity of the logical operation, including its data layer attributes, input data attributes and the syntax of its expressions. Also, the logical operation verifier 125 may confirm that the attributes entered by the user actually exist within supplied pattern data. The system 110 may be linked with one or more sets of rules that are preferably separately stored, and thus easily updateable, which can be used to insure complete and accurate data is included in the logical operation. For example, a set of rules relating to expressions, including rules governing the proper aliases that can be used in the expressions, may be used to verify the syntax of the expression in a logical operation. It should be appreciated that the logical operation may also be sent to a photomask manufacturer's computer system for verification.

The tooling specification generator 130 allows the end user to generate a tooling specification, which will then be parsed and used to fracture data. The tooling specification is essentially a representation of the expressions in a logical operation that will contain the data fracturing instructions for one or more photomask layers. More than one tooling specification may be generated from one logical operation. Once generated, the tooling specification can be printed and/or saved to a user-specified location, such as, for example, a local disk device, a portable storage device or a network device, to name a few.

The file transmitter 135 is able to create a compressed file containing one or more tooling specification files for sending to a designated site via any application supported transfer protocol, such as FTP, HTTP or SMTP, to name a few. The compressed file may be in any suitable format, such as, for example, gzip. In one example, the designated site may be a photomask manufacturer, in which case the photomask manufacturer would “unzip” or decompress the files, to the extent necessary, and use the tooling specification to manufacture the required photomask.

The tooling specification translator 140 is able to translate a saved or imported tooling specification into a format that can be used by third party data fracturing applications, such as, for example, K2, CATS, Calibre, Synopsis and Mask Composer, to name a few. For example, a tooling specification in the form of a previously generated XML document can be opened within the tooling specification generating system 110, after which the system 110 will parse through the document and generate a new file that is compatible with a data fracturing utility. In this regard, the system 110 may further allow the end user to define default values for one or more attributes to be used when creating a logical operation or generating a tooling specification so as to satisfy requirements of various data fracturing applications. A set of updateable and separately stored rules may be used as a guide in determining whether the chosen default values would work with a particular data fracturing application.

The various attributes that make up a logical operation may also be chosen and/or modified by an end user using look-up lists. The look-up lists may be pre-populated and non-editable, pre-populated and editable, or empty and editable. For example, if the tooling specification generating system 110 is integrated with the photomask order generating system 145, such as MaskPilot®, the system 110 may share look-up list values for attributes that are common between the system 110 and the photomask order generating system 145. As another example, the tooling specification generating system 110 may be a stand-alone system, in which case the look-up lists may contain values for attributes that are compatible with a separate photomask order generating system 145.

The photomask manufacturer's computer system may include a simulation utility 210 and an analysis utility 215. The simulation utility may use any suitable proprietary and/or commercial photomask design simulation software, such as, for example, SiVL by Synopsis, to simulate a photomask design based on the tooling specification generated by the tooling specification generating system 110. In this regard, the photomask customer's computer system 100 may be linked to the photomask manufacturer's computer system via a network, for example.

The analysis utility 215 may be used to analyze the generated tooling specification. The analysis may be based on the simulated photomask design, or may be performed separately from the simulation. In addition, in other exemplary embodiments of the invention, the tooling specification generating system 110 may itself be capable of performing the photomask design simulation. The tooling specification analysis preferably produces results regarding the validity, feasibility and/or desirability of the photomask design. For example, the analysis may provide hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios, to name a few. In general, the analysis preferably results in information which the photomask customer may use to improve and/or correct its tooling specification, resulting in less expensive photomask manufacturing process costs and reduced cycle time. In at least one embodiment of the invention, the photomak manufacturer's computer system modifies the tooling specification before sending it back to the photomask customer's computer system.

The photomask manufacturer's computer system also may include a photomask order processing system 220 that receives and processes the photomask order to manufacture the desired photomask.

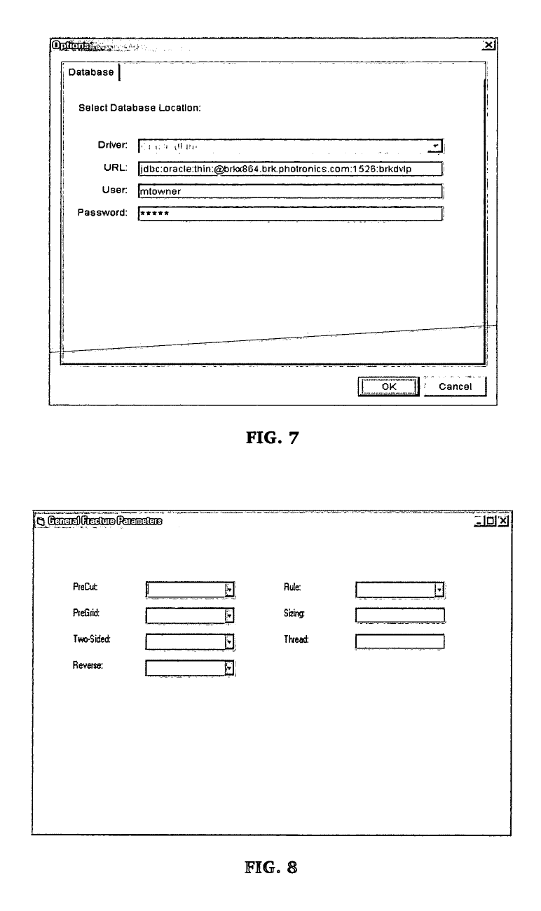

The end user can interact with the tooling specification generating system 110 through a graphics utility interface (GUI), a traditional wizard or a command generator. A GUI guides the end user to enter correct and accurate information into the system 112 for the generation of a tooling specification. FIGS. 7-13 shows various screens of a GUI useable with the tooling specification generating system 110 according to an exemplary embodiment of the invention. The screens can be accessed using a menu structure displayed at a startup screen, such as the following:

| Main Menu | SubMenu |
|---|---|
| File> | New . . . |
| | Create From . . . |
| | Open . . . |
| | Import . . . |
| | Close . . . |
| | Save . . . |
| | Save As . . . |
| | Verify Logical Operation . . . |
| | Verify Input Data . . . |
| | Submit . . . |
| | Delete . . . |
| | Properties . . . |
| | Exit . . . |
| Edit> | Cut . . . |
| | Copy . . . |
| | Paste . . . |
| View> | Logical Operation . . . |
| | Pattern Group . . . |
| | Input Data . . . |
| | Logical Expression . . . |
| Tools> | Transmit . . . |
| | Lookup Lists . . . |
| | Alias Maintenance . . . |
| | FTP Account . . . |
| | View Tooling Specification . . . |
| | Extract Layer Data . . . |
| | Options . . . |
| Help> | Contents . . . |
| | About . . . |

As an example, clicking on the “Options” submenu will result in the display of a number of tab screens, such as the “Database” tab screen 145 shown in FIG. 7. The “Database” tab screen 145 allows the end user to designate a path in which the system 110 will be able to locate files it needs to extract data. In the example shown in FIG. 7, the “Database” tab screen 145 allows the end user to choose the URL from which data will be extracted, and requires entry of a User ID and Password if necessary to access the URL.

The GUI may further include a “general fracture parameters” screen 150, as shown in FIG. 8. This screen would allow an end user to set the parameters for fracturing the data used to manufacture the photomask layers. As shown in FIG. 8, the “general fracture parameters” screen 150 may include items for which values can be chosen from a set list, such as “PreCut”, “PreGrid”, “Two-Sided”, “Reverse” and “Rule”, and items for which values are not chosen from a set list, such as “Sizing” and “Thread”. The items displayed on the “general fracture parameters” screen 150 are not limited to those shown in FIG. 8.

The logical operation can be viewed and/or modified from a “Logical Operation” screen 155, as shown in FIG. 9. This screen would allow, among other things, entry and/or display of the “Logical Operation Name”, which is given to a particular logical operation upon its creation.

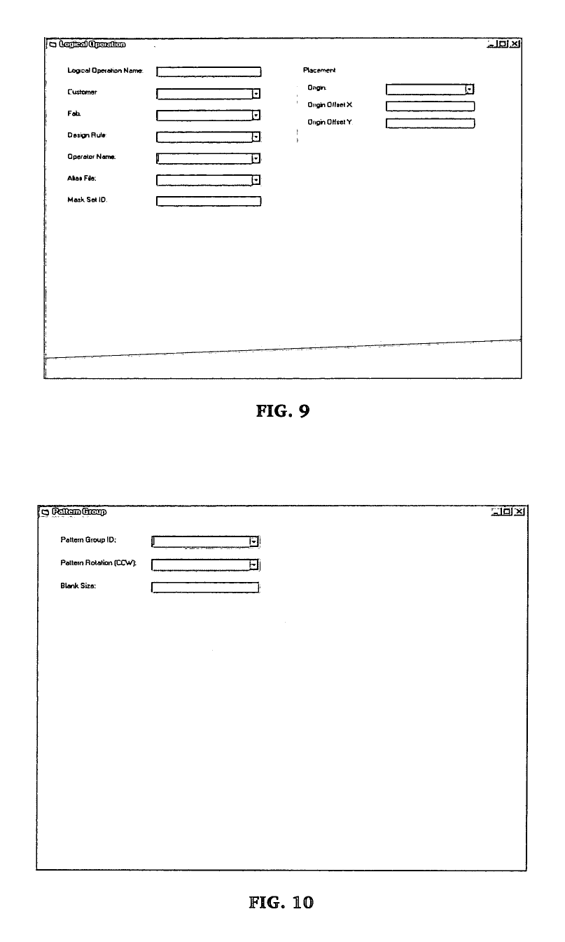

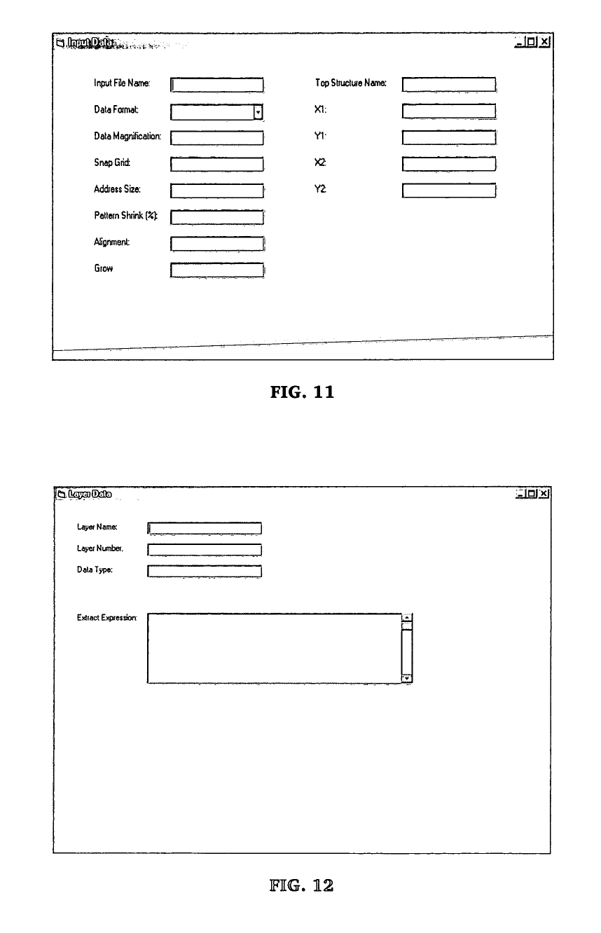

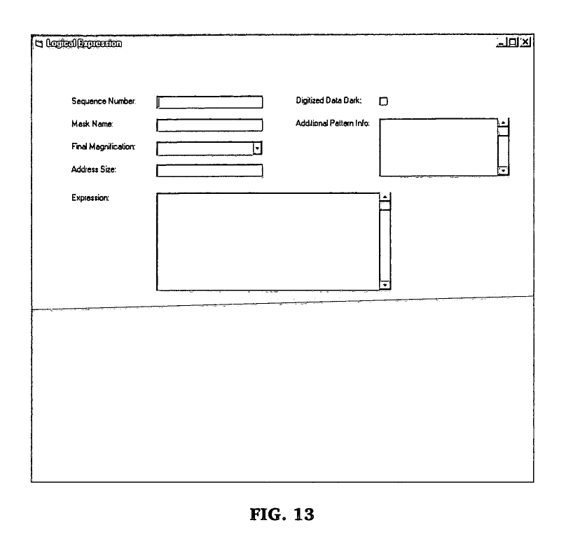

The GUI may also include a screen relating to each of the components of the logical operation. For example, FIG. 10 shows a “Pattern Group” screen 160, FIG. 11 shows an “Input Data” screen 165, FIG. 12 shows a “Layer Data” screen 170 and FIG. 13 shows a “Logical Expression” screen 175.

In exemplary embodiments of the invention, the tooling specification generating system 110 may be a stand-alone system that may be used in conjunction with a separate photomask order generating system, such as MaskPilot®. Alternatively, the tooling specification generating system 110 may be integrated with a photomask order generating system. As mentioned previously, integrating the tooling specification generating system 110 with the photomask order generating system allows the two systems to share information, such as sharing look-up lists and informational databases, which provides advantages such entry of data in a common format and elimination of the need to enter the same information twice.

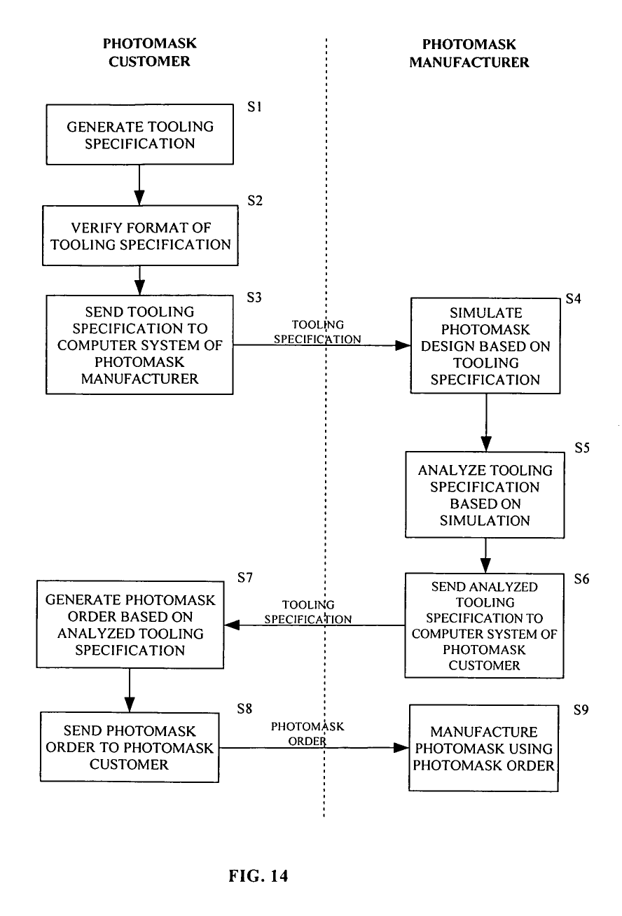

FIG. 14 is a flowchart showing a method of manufacturing a photomask using the tooling specification generating system 110 according to an exemplary embodiment of the invention. At step S1, a tooling specification is generated by the tooling specification generating system 110 after entry of the appropriate attributes of a logical operation into the logical operation manager 115. During this step, the alias manager 120 may be used to create an alias for any operator used in the logical operation. As an alternative to step S1, a previously saved tooling specification may be retrieved or a tooling specification may be imported from an external source.

At step S2, the format of the generated tooling specification is verified by the logical operation verifier 125. For example, in this step, the syntax of the logical operation may be verified using a previously generated set of rules. These rules may determine, for example, the correct order of objects in the logical operation and/or the required attributes for each logical operation. If errors are found in the format of the tooling specification, the tooling specification may be regenerated to correct the errors and verified one again. The verification step is optional, and in other exemplary embodiments the tooling specification may be generated without verification of the logical operation format. Verification of the logical operation may be performed by either the photomask customer's computer or the photomask manufacturer's computer.

At step S3, the tooling specification is sent to the photomask manufacturer's computer system 200 using the file transmitter 135. In this step, the tooling specification may be outputted in a number of standard and/or proprietary photomask order formats so that the computer system of the photomask manufacturer can read the tooling specification. An example of a standard format may be a format recognized and used by photolithography equipment or software associated with Computer Aided Design or Electronic Design Automation, to name a few. Proprietary formats may include XML, SOAP XML, post-script, and HTML, to name a few.

At step S4, the photomask manufacturer's computer system simulates the photomask design based on the fracturing instructions contained within the tooling specification received from the photomask customer's computer system. In this step, the photomask manufacturer may use any suitable commercial and/or proprietary photomask design simulation software, such as, for example, SiVL by Synopsis.

In step S4, the photomask manufacturer's computer system analyzes the tooling specification based on the photomask design simulation results. It should be appreciated that the simulation step is optional, and the analysis of the photomask design may be completed without such simulation. Furthermore, the simulation step may also be performed after analysis, and/or by the tooling specification generating system 110 without requiring analysis. In step S4, the tooling specification is analyzed based on the validity, feasibility and/or desirability of the resulting photomask design. As discussed previously, the analysis preferably results in information which the photomask customer may use to improve and/or correct its tooling specification, resulting in less expensive photomask manufacturing process costs and reduced cycle time.

In step S6, the photomask manufacturer's computer system sends the analysis results to the photomask customer's computer system with or without the tooling specification. If sent with the tooling specification, the analysis results may be incorporated into the tooling specification file. The analysis results may be sent alone or separately from the tooling specification as, for example, an XML or HTML document. In addition, the photomask manufacturer's computer system may modify the tooling specification based on the analysis.

In step S7, after receiving the analysis results, the photomask customer's computer system generates a photomask order using the tooling specification. In this step, the tooling specification may first be modified based on the analysis results provided by the photomask manufacturer before generating the photomask order. For example, the analysis results may indicate that the tooling specification is not valid, thereby requiring modification of the logical operation, or the tooling specification may be altered to comply with changes suggested by the photomask manufacturer that would result in an improved photomask design. The photomask order may be generated using any suitable photomask order generating system, such as MaskPilot®. In at least one embodiment of the invention, the file will be in a form to be compatible with more than one photomask manufacturer's order format.

In step S8, the photomask order is sent to a photomask manufacturer. The order need not be sent to the same photomask manufacturer that performed the analysis. Finally, in step S9, the photomask manufacturer manufactures the photomask using the photomask order.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. A method of manufacturing a photomask comprising the steps of:
receiving a tooling specification from a computer system of a photomask customer;
analyzing the tooling specification;
sending results of the analysis to the computer system of the photomask customer;
receiving a photomask order generated based on the tooling specification; and
manufacturing a photomask based on the photomask order.

2. The method of claim 1, wherein the tooling specification is received in at least one of various proprietary and standard photomask data formats.

3. The method of claim 2, wherein the various proprietary and standard photomask data formats comprise at least one of: GDSII, MEBES, Oasis, DXF, Applican, .cflt, .cinc and .ps.

4. The method of claim 1, wherein the tooling specification is analyzed to determine at least one of validity, feasibility and desirability of the tooling specification.

5. The method of claim 4, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

6. The method of claim 1, further comprising the step of sending the tooling specification back to the computer system of the photomask customer after analyzing the tooling specification.

7. The method of claim 6, further comprising the step of modifying the tooling specification based on the analysis before sending the tooling specification back to the computer system of the photomask customer.

8. The method of claim 1, further comprising the step of simulating a photomask design using the tooling specification.

9. The method of claim 8, wherein the tooling specification is analyzed using the simulated photomask design.

10. A method of generating a photomask order used to manufacture photomasks comprising the steps of:
generating a tooling specification by creating, modifying and/or deleting components of a logical operation that is represented by the tooling specification;
sending the tooling specification to a computer system of a photomask manufacturer for analysis of the tooling specification;
receiving results of the analysis from the computer system of the photomask manufacturer;
generating a photomask order based on the tooling specification; and
sending the photomask order to the computer system of the photomask manufacturer.

11. The method of claim 10, wherein the components of the logical operation comprise at least one of: data layer attributes, input data attributes, expressions, pattern groups and aliases.

12. The method of claim 10, further comprising the step of importing data for the components of the logical operation from an external source.

13. The method of claim 12, wherein the step of importing data is done using at least one of a command line generator and a scanner.

14. The method of claim 12, wherein the external source is at least one of: a database, a GDSII file, a MEBES file and a photomask order template.

15. The method of claim 14, wherein the external source is a database, and the database is shared with the computer system of the photomask manufacturer.

16. The method of claim 10, wherein at least one of the components of the logical operation is chosen from at least one look-up list.

17. The method of claim 11, wherein the components of the logical operation comprise at least one alias, and the method further comprises the step of modifying the at least one alias from its default value.

18. The method of claim 10, further comprising the step of verifying format of the tooling specification.

19. The method of claim 18, wherein the format of the tooling specification is verified using a set of rules.

20. The method of claim 10, further comprising the step of translating the tooling specification into a format that can be used by third party data fracturing applications.

21. The method of claim 10, wherein the tooling specification is generated in at least one of various proprietary and standard photomask data formats.

22. The method of claim 21, wherein the various proprietary and standard photomask data formats comprise at least one of: GDSII, MEBES, Oasis, DXF, Applican, .cflt, .cinc and .ps.

23. The method of claim 10, further comprising the step of entering data for the components of the logical operation using at least one of a graphics utility interface, a wizard and a command generator.

24. The method of claim 23, wherein the step of entering data is done using a graphics utility interface.

25. The method of claim 23, wherein the step of entering data is done using a wizard.

26. The method of claim 23, wherein the step of entering data is done using a command generator.

27. The method of claim 10, wherein the computer system of the photomask manufacturer analyzes the tooling specification to determine at least one of validity, feasibility and desirability of the tooling specification.

28. The method of claim 27, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

29. The method of claim 10, further comprising the step of simulating a photomask design using the tooling specification.

30. The method of claim 29, wherein the tooling specification is analyzed using the simulated photomask design.

31. A method of processing a photomask order comprising the steps of:
receiving a tooling specification from a computer system of a photomask customer;
analyzing the tooling specification;
sending results of the analysis to the computer system of the photomask customer; and
receiving a photomask order generated based on the tooling specification.

32. The method of claim 31, wherein the tooling specification is received in at least one of various proprietary and standard photomask data formats.

33. The method of claim 32, wherein the various proprietary and standard photomask data formats comprise at least one of: GDSII, MEBES, Oasis, DXF, Applican, .cflt, .cinc and .ps.

34. The method of claim 31, wherein the tooling specification is analyzed to determine at least one of validity, feasibility and desirability of the tooling specification.

35. The method of claim 34, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

36. The method of claim 31, further comprising the step of sending the tooling specification back to the computer system of the photomask customer after analyzing the tooling specification.

37. The method of claim 36, further comprising the step of modifying the tooling specification based on the analysis before sending the tooling specification back to the computer system of the photomask customer.

38. The method of claim 31, further comprising the step of simulating a photomask design using the tooling specification.

39. The method of claim 38, wherein the tooling specification is analyzed using the simulated photomask design.

40. A method of generating a tooling specification using a tooling specification generating system, comprising the steps of:
importing data relating to at least one component of a logical operation from a source external to the specification generating system;
generating a tooling specification based on the at least one component of the logical operation; and
sending the tooling specification to a computer system of a photomask manufacturer for analysis of the tooling specification.

41. The method of claim 40, further comprising the step of generating a photomask order based on the tooling specification.

42. The method of claim 40, wherein the at least one component of the logical operation comprises at least one of: data layer attributes, input data attributes, expressions, pattern groups and aliases.

43. The method of claim 40, wherein the step of importing is done using at least one of a command line generator and a scanner.

44. The method of claim 40, wherein the external source is at least one of a database, a GDSII file, a MEBES file and a photomask order template.

45. The method of claim 40, wherein the external source is a database, and the database is shared with the computer system of the photomask manufacturer.

46. The method of claim 40, further comprising the step of choosing at least one other component of the logical operation from at least one look-up list.

47. The method of claim 40, further comprising the step of verifying format of the tooling specification.

48. The method of claim 47, wherein the format of the tooling specification is verified using a set of rules.

49. The method of claim 40, further comprising the step of translating the tooling specification into a format that can be used by third party data fracturing applications.

50. The method of claim 40, wherein the tooling specification is generated in at least one of various proprietary and standard photomask data formats.

51. The method of claim 50, wherein the various proprietary and standard photomask data formats comprise GDSII, MEBES, Oasis, DXF, Applican, .cflt, .cinc and .ps.

52. The method of claim 40, further comprising the step of entering data for at least one other component of the logical operation using at least one of a graphics utility interface, a wizard and a command generator.

53. The method of claim 40, wherein the step of entering data for at least one other component is done using a graphics utility interface.

54. The method of claim 40, wherein the step of entering data for at least one other component is done using a wizard.

55. The method of claim 40, wherein the step of entering data for at least one other component is done using a command generator.

56. The method of claim 40, wherein the computer system of the photomask manufacturer analyzes the tooling specification to determine at least one of validity, feasibility and desirability of the tooling specification.

57. The method of claim 56, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

58. The method of claim 40, further comprising the step of simulating a photomask design using the tooling specification.

59. The method of claim 58, wherein the tooling specification is analyzed using the simulated photomask design.

60. A method of generating a tooling specification used to manufacture photomasks comprising the steps of:
generating a tooling specification by creating, modifying and/or deleting components of a logical operation that is represented by the tooling specification; and
outputting the tooling specification in a format in accordance with a particular standard and/or proprietary photomask order format.

61. The method of claim 60, further comprising the step of verifying format of the tooling specification.

62. The method of claim 61, wherein the format of the tooling specification is verified using a set of rules.

63. The method of claim 61, wherein the various proprietary and standard photomask data formats comprise at least one of: GDSII, MEBES, Oasis, DXF, Applican, .cflt, .cinc and .ps.

64. A method of generating a photomask order used to manufacture photomasks comprising the steps of:
generating a tooling specification by creating, modifying and/or deleting at least one component of a logical operation using at least one of a graphical user interface, a wizard and a command generator, the logical operation being represented by the tooling specification;
sending the tooling specification to a computer system of a photomask manufacturer for analysis of the tooling specification;
receiving the analysis from the computer system of the photomask manufacturer;
generating a photomask order based on the tooling specification; and
sending the photomask order to the computer system of the photomask manufacturer.

65. The method of claim 64, wherein the components of the logical operation comprise at least one of: data layer attributes, input data attributes, expressions, pattern groups and aliases.

66. The method of claim 64, further comprising the step of importing data for at least one other component of the logical operation from an external source.

67. The method of claim 66, wherein the step of importing data is done using at least one of a command line generator and a scanner.

68. The method of claim 66, wherein the external source is at least one of: a database, a GDSII file, a MEBES file and a photomask order template.

69. The method of claim 68, wherein the external source is a database, and the database is shared with the computer system of the photomask manufacturer.

70. The method of claim 66, wherein at least one other component of the logical operation is chosen from at least one look-up list.

71. The method of claim 64, wherein the at least one component of the logical operation comprise at least one alias, and the method further comprises the step of modifying the at least one alias from its default value.

72. The method of claim 64, further comprising the step of verifying format of the tooling specification.

73. The method of claim 72, wherein the format of the tooling specification is verified using a set of rules.

74. The method of claim 64, further comprising the step of translating the tooling specification into a format that can be used by third party data fracturing applications.

75. The method of claim 64, wherein the tooling specification is generated in at least one of various proprietary and standard photomask data formats.

76. The method of claim 75, wherein the various proprietary and standard photomask data formats comprise at least one of: GDSII, MEBES, Oasis, DXF, Applican, .cflt, .cinc and .ps.

77. The method of claim 64, wherein the step of generating a tooling specification is done using a graphics utility interface.

78. The method of claim 64, wherein the step of generating a tooling specification is done using a wizard.

79. The method of claim 64, wherein the step of generating a tooling specification is done using a command generator.

80. The method of claim 64, wherein the computer system of the photomask manufacturer analyzes the tooling specification to determine at least one of validity, feasibility and desirability of the tooling specification.

81. The method of claim 80, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

82. The method of claim 64, further comprising the step of simulating a photomask design using the tooling specification.

83. The method of claim 82, wherein the tooling specification is analyzed using the simulated photomask design.

84. A photomask order generating system used to manufacture photomasks comprising:
a tooling specification generator for creating, modifying and/or deleting components of a logical operation that is represented by a tooling specification;
a tooling specification analyzer that analyzes the tooling specification; and
a photomask order generator that generates a photomask order based on the tooling specification and transmits the photomask order to a computer system of a photomask manufacturer.

85. The system of claim 84, wherein the tooling specification analyzer comprises a file transmitter that transmits the tooling specification to a computer system of a photomask manufacturer for analysis of the tooling specification.

86. The system of claim 84, wherein the components of the logical operation comprise at least one of: data layer attributes, input data attributes, expressions, pattern groups and aliases.

87. The system of claim 84, further comprising a data importer that imports data for at least one of the components of the logical operation from an external source.

88. The system of claim 87, wherein the data importer comprises at least one of a command line generator and a scanner.

89. The system of claim 87, wherein the external source is at least one of: a database, a GDSII file, a MEBES file and a photomask order template.

90. The system of claim 89, wherein the external source is a database, and the database is shared with the computer system of the photomask manufacturer.

91. The system of claim 84, further comprising at least one look-up list from which at least one of the components of the logical operation is chosen.

92. The system of claim 86, wherein the components of the logical operation comprise at least one alias, and the system further comprises an alias manager for modifying the at least one alias from its default value.

93. The system of claim 84, further comprising a logical operation verifier for verifying format of the logical operation.

94. The system of claim 93, wherein the logical operation verifier uses a set of rules to verify the format of the logical operation.

95. The system claim 84, further comprising a tooling specification translator for translating the tooling specification into a format that can be used by third party data fracturing applications.

96. The system of claim 84, wherein the tooling specification generator generates the tooling specification in at least one of various proprietary and standard photomask data formats.

97. The system of claim 96, wherein the various proprietary and standard photomask data formats comprise at least one of: GDSII, MEBES, Oasis, DXF, Applican, .cflt, .cinc and .ps.

98. The system of claim 84, further comprising at least one of a graphics utility interface, a wizard and a command generator for entering data for the components of the logical operation.

99. The system of claim 84, further comprising a graphics utility interface for entering data for the components of the logical operation.

100. The system of claim 84, further comprising a wizard for entering data for the components of the logical operation.

101. The system of claim 84, further comprising a command generator for entering the components of the logical operation.

102. The system of claim 84, wherein the tooling specification analyzer analyzes the tooling specification to determine at least one of validity, feasibility and desirability of the tooling specification.

103. The system of claim 102, wherein the tooling specification analyzer produces analysis results regarding at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

104. The system of claim 84, further comprising a photomask design simulator for simulating a photomask design using the tooling specification.

105. The system of claim 104, wherein the tooling specification analyzer analyzes the tooling specification using the photomask design simulated by the photomask design simulator.

106. A photomask order generating system used to manufacture photomasks comprising:
a tooling specification generator for creating, modifying and/or deleting components of a logical operation that is represented by the tooling specification, the tooling specification including fracturing instructions for a photomask design;
a photomask design simulator that simulates the photomask design using the fracturing instructions; and
a photomask order generator that generates a photomask order based on the tooling specification and that transmits the photomask order to a computer system of a photomask manufacturer.

107. The system of claim 106, further comprising a tooling specification analyzer for analyzing the tooling specification.

108. The system of claim 107, wherein the tooling specification analyzer transmits the tooling specification to a computer system of a photomask manufacturer for analysis of the tooling specification.

109. The system of claim 106, wherein the components of the logical operation comprise at least one of: data layer attributes, input data attributes, expressions, pattern groups and aliases.

110. The system of claim 106, further comprising a data importer that imports data for at least one of the components of the logical operation from an external source.

111. The system of claim 110, wherein the data importer comprises at least one of a command line generator and a scanner.

112. The system of claim 110, wherein the external source is at least one of: a database, a GDSII file, a MEBES file and a photomask order template.

113. The system of claim 110, wherein the external source is a database, and the database is shared with the computer system of the photomask manufacturer.

114. The system of claim 106, further comprising at least one look-up list from which at least one of the components of the logical operation is chosen.

115. The system of claim 109, wherein the components of the logical operation comprise at least one alias, and the system further comprises an alias manager for modifying the at least one alias from its default value.

116. The system of claim 106, further comprising a logical operation verifier for verifying format of the logical operation.

117. The system of claim 116, wherein the logical operation verifier uses a set of rules to verify the format of the logical operation.

118. The system of claim 106, further comprising a tooling specification translator for translating the tooling specification into a format that can be used by third party data fracturing applications.

119. The system of claim 106, wherein the tooling specification generator generates the tooling specification in at least one of various proprietary and standard photomask data formats.

120. The system of claim 119, wherein the various proprietary and standard photomask data formats comprise at least one of: GDSII, MEBES, Oasis, DXF, Applican, .cflt, .cinc and .ps.

121. The system of claim 106, further comprising at least one of a graphics utility interface, a wizard and a command generator for entering data for the components of the logical operation.

122. The system of claim 106, further comprising a graphics utility interface for entering data for the components of the logical operation.

123. The system of claim 106, further comprising a wizard for entering data for the components of the logical operation.

124. The system of claim 106, further comprising a command generator for entering the components of the logical operation.

125. The system of claim 106, wherein the tooling specification analyzer analyzes the tooling specification to determine at least one of validity, feasibility and desirability of the tooling specification.

126. The system of claim 125, wherein the tooling specification analyzer produces analysis results regarding at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

127. The system of claim 107, wherein the tooling specification analyzer analyzes the tooling specification using the photomask design simulated by the photomask design simulator.

128. A method for generating a photomask order used to manufacture photomasks comprising the steps of:
generating a tooling specification by creating, modifying and/or deleting components of a logical operation that is represented by the tooling specification, the tooling specification including fracturing instructions for a photomask design;
simulating the photomask design using the fracturing instructions;
analyzing the tooling specification based on the simulated photomask design;
generating a photomask order based on the tooling specification; and
transmitting the photomask order to a computer system of a photomask manufacturer.

129. The method of claim 128, wherein the components of the logical operation comprise at least one of: data layer attributes, input data attributes, expressions, pattern groups and aliases.

130. The method of claim 128, further comprising the step of importing data for the components of the logical operation from an external source.

131. The method of claim 130, wherein the step of importing data is done using at least one of a command line generator and a scanner.

132. The method of claim 130, wherein the external source is at least one of: a database, a GDSII file, a MEBES file and a photomask order template.

133. The method of claim 132, wherein the external source is a database, and the database is shared with the computer system of the photomask manufacturer.

134. The method of claim 128, wherein at least one of the components of the logical operation is chosen from at least one look-up list.

135. The method of claim 129, wherein the components of the logical operation comprise at least one alias, and the method further comprises the step of modifying the at least one alias from its default value.

136. The method of claim 128, further comprising the step of verifying format of the tooling specification.

137. The method of claim 136, wherein the format of the tooling specification is verified using a set of rules.

138. The method of claim 128, further comprising the step of translating the tooling specification into a format that can be used by third party data fracturing applications.

139. The method of claim 128, wherein the tooling specification is generated in at least one of various proprietary and standard photomask data formats.

140. The method of claim 139, wherein the various proprietary and standard photomask data formats comprise at least one of: GDSII, MEBES, Oasis, DXF, Applican, .cflt, .cinc and .ps.

141. The method of claim 128, further comprising the step of entering data for the components of the logical operation using at least one of a graphics utility interface, a wizard and a command generator.

142. The method of claim 141, wherein the step of entering data is done using a graphics utility interface.

143. The method of claim 141, wherein the step of entering data is done using a wizard.

144. The method of claim 141, wherein the step of entering data is done using a command generator.

145. The method of claim 128, wherein the tooling specification is analyzed to determine at least one of validity, feasibility and desirability of the tooling specification.

146. The method of claim 145, wherein results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

147. A method of generating a photomask order used to manufacture photomasks comprising the steps of:
generating a tooling specification by creating, modifying and/or deleting components of a logical operation that is represented by the tooling specification;
verifying that the tooling specification is in a proper format;
sending the tooling specification to a computer system of a photomask manufacturer for analysis of the tooling specification;
receiving the analysis from the computer system of the photomask manufacturer;
generating a photomask order based on the tooling specification; and
sending the photomask order to the computer system of the photomask manufacturer.

148. The method of claim 147, wherein the components of the logical operation comprise at least one of: data layer attributes, input data attributes, expressions, pattern groups and aliases.

149. The method of claim 147, further comprising the step of importing data for the components of the logical operation from an external source.

150. The method of claim 149, wherein the step of importing data is done using at least one of a command line generator and a scanner.

151. The method of claim 149, wherein the external source is at least one of: a database, a GDSII file, a MEBES file and a photomask order template.

152. The method of claim 151, wherein the external source is a database, and the database is shared with the computer system of the photomask manufacturer.

153. The method of claim 147, wherein at least one of the components of the logical operation is chosen from at least one look-up list.

154. The method of claim 147, wherein the components of the logical operation comprise at least one alias, and the method further comprises the step of modifying the at least one alias from its default value.

155. The method of claim 147, wherein the format of the tooling specification is verified using a set of rules.

156. The method of claim 147, further comprising the step of translating the tooling specification into a format that can be used by third party data fracturing applications.

157. The method of claim 147, wherein the tooling specification is generated in at least one of various proprietary and standard photomask data formats.

158. The method of claim 157, wherein the various proprietary and standard photomask data formats comprise at least one of: GDSII, MEBES, Oasis, DXF, Applican, .cflt, .cinc and .ps.

159. The method of claim 147, further comprising the step of entering data for the components of the logical operation using at least one of a graphics utility interface, a wizard and a command generator.

160. The method of claim 159, wherein the step of entering data is done using a graphics utility interface.

161. The method of claim 159, wherein the step of entering data is done using a wizard.

162. The method of claim 159, wherein the step of entering data is done using a command generator.

163. The method of claim 147, wherein the computer system of the photomask manufacturer analyzes the tooling specification to determine at least one of validity, feasibility and desirability of the tooling specification.

164. The method of claim 163, wherein the results of the analysis comprise at least one of hot spot and metrology mapping, mask manufacturing rule violations, statistics on feature count and layout density, lithography printing and variability sensitivity analysis, mask cost and cycle time estimate and suggestions for reduction, mask specification consistent with lithography needs, full chip process window and/or CD control estimates and potential for alternate RET scenarios.

165. The method of claim 147, further comprising the step of simulating a photomask design using the tooling specification.

166. The method of claim 165, wherein the tooling specification is analyzed using the simulated photomask design.

167. A method of generating a tooling specification used to manufacture photomasks comprising the steps of:
at least one of creating, modifying and deleting components of a logical operation, the components comprising at least one expression having an operator and at least one alias corresponding to the operator;
modifying the at least one alias from a default value; and
generating a tooling specification based on the logical operation comprising the modified at least one alias.

168. The method of claim 167, further comprising sending the tooling specification to a computer system of the photomask manufacturer for analysis of the tooling specification.

169. The method of claim 167, further comprising the step of verifying format of the tooling specification.

170. The method of claim 167, further comprising the step of simulating a photomask design based on the tooling specification.

171. The method of claim 167, further comprising the step of importing data for at least one of the components of the logical operation from an external source.

172. The method of claim 171, wherein the step of importing data is done using at least one of a command line generator and a scanner.

173. The method of claim 171, wherein the external source is at least one of: a database, a GDSII file, a MEBES file and a photomask order template.

174. The method of claim 173, wherein the external source is a database, and the database is shared with a computer system of a photomask manufacturer.

175. The method of claim 167, wherein at least one of the components of the logical operation is chosen from at least one look-up list.

176. A tooling specification generating system used to manufacture photomasks comprising:
a logical operations manager for at least one of creating, modifying and deleting components of a logical operation, the components comprising at least one expression having an operator and at least one alias corresponding to the operator;
an alias manager for modifying the at least one alias from a default value; and
a tooling specification generator that generates a tooling specification based on the logical operation comprising the modified at least one alias.

177. The system of claim 176, further comprising a tooling specification analyzer that sends the tooling specification to a computer system of a photomask manufacturer for analysis of the tooling specification.

178. The system of claim 176, further comprising a tooling specification verifier for verifying format of the tooling specification.

179. The system of claim 176, further comprising a photomask design simulator that simulates a photomask design based on the tooling specification.

180. The system of claim 176, further comprising a data importer for importing data for at least one of the components of the logical operation from an external source.

181. The system of claim 180, wherein the data importer comprises at least one of a command line generator and a scanner.

182. The system of claim 180, wherein the external source is at least one of: a database, a GDSII file, a MEBES file and a photomask order template.

183. The system of claim 182, wherein the external source is a database, and the database is shared with a computer system of a photomask manufacturer.

184. The system of claim 176, further comprising at least one look-up list from which at least one of the components of the logical operation is chosen.

185. A computer readable medium containing computer readable instructions for a computer to perform a method comprising the steps of:
generating a tooling specification by creating, modifying and/or deleting components of a logical operation that is represented by the tooling specification;
sending the tooling specification to a computer system of a photomask manufacturer for analysis of the tooling specification;
receiving the tooling specification from the computer system of the photomask manufacturer;
generating a photomask order based on the tooling specification; and
sending the photomask order to the computer system of the photomask manufacturer.

186. A tooling specification generating system comprising:
a data importer for importing data relating to at least one component of a logical operation from a source external to the tooling specification generating system;
a tooling specification generator for generating a tooling specification based on the at least one component of the logical operation; and
a tooling specification analyzer comprising a file transmitter that transmits the tooling specification to a computer system of a photomask manufacturer for analysis of the tooling specification.

187. The system of claim 186, wherein the data importer comprises at least one of a command line generator and a scanner.

188. The system of claim 186, wherein the external source is at least one of: a database, a GDSII file, a MEBES file and a photomask order template.

189. The system of claim 188, wherein the external source is a database, and the database is shared with the computer system of the photomask manufacturer.

190. A photomask order generating system comprising:
a tooling specification generator for creating, modifying and/or deleting at least one component of a logical operation using at least one of a graphical user interface, a wizard and a command generator, the logical operation being represented by the tooling specification;
a tooling specification analyzer that sends the tooling specification to a computer system of a photomask manufacturer for analysis of the tooling specification; and
a photomask order generator that generates a photomask order based on the tooling specification and that sends the photomask order to the computer system of the photomask manufacturer.

191. The system of claim 190, wherein the tooling specification generator comprises a graphics utility interface.

192. The system of claim 190, wherein the tooling specification generator comprises a wizard.

193. The system of claim 190, wherein the tooling specification generator comprises a command generator.

194. A photomask order generating system comprising:
a tooling specification generator for creating, modifying and/or deleting components of a logical operation that is represented by the tooling specification;
a logical operation verifier for verifying that the logical operation is in a proper format;
a tooling specification analyzer that sends the tooling specification to a computer system of a photomask manufacturer for analysis of the tooling specification; and
a photomask order generator that generates a photomask order based on the tooling specification and that sends the photomask order to the computer system of the photomask manufacturer.

195. The system of claim 194, wherein the logical operation verifier uses a set of rules to verify the format of the logical operation.
